(19) United States
(12) Patent Application Publication
(10) Pub. No.: US 2015/0116754 A1
(43) Pub. Date: Apr. 30, 2015

(54) IMAGE FORMING APPARATUS, METHOD OF DELETING PRINT REQUEST, AND PROGRAM

(71) Applicant: Kyohhei MUKAI, Kanagawa (JP)

(72) Inventor: Kyohhei MUKAI, Kanagawa (JP)

(73) Assignee: RICOH COMPANY, LTD., Tokyo (JP)

(21) Appl. No.: 14/516,662

(22) Filed: Oct. 17, 2014

(30) Foreign Application Priority Data
Oct. 31, 2013 (JP) 2013-226355

(51) Int. Cl. G06F 3/12

(52) U.S. Cl. CPC G06F 3/1238; G06F 3/1222; G06F 3/1234; G06F 3/1274
USPC 358/1.14

(57) ABSTRACT

An image forming apparatus that performs a print process based on a print request for data to be printed includes a detecting unit that detects an occurrence of an error by which the print process is ceased; and a deleting unit that checks print request deletion setup information when a request of a user to end a usage and the occurrence of the error ceasing the print process is detected by the detecting unit, and deletes the print request in a case where a setup of deleting the print request is provided at a time of requesting to end the usage.

### BACKGROUND OF THE INVENTION

1. Field of the Invention

The present invention relates to an image forming apparatus, a method of deleting print request, and a program.

2. Description of the Related Art

For example, Japanese Laid-Open Patent Publication No. 2007-304798 discloses a print system with which a print job stored in a printer can be checked or deleted by a user even in a case where the user moves into an environment where the user cannot access the printer through the network after sending a print job to the printer.

When a print error occurs by a run out of paper, a paper jam, or the like, a print process based on the print job is ceased. Further, the image forming apparatus resumes the print process based on the print job when the print error is solved.

In a print system using such an image forming apparatus, the user resends the print job to another image forming apparatus and performs a print process based on the print job when the print error occurs in the image forming apparatus which has sent the print job.

However, when another user solves the print error of the image forming apparatus in which the error occurs, the image forming apparatus resumes the print process based on the ceased print job. Therefore, if a user does not deal with the print error occurring in the image forming apparatus which sends the print job, a print document of the user may be unintentionally viewed by another user. As such, there is a possibility of causing a security problem in the image forming apparatus in which the print error occurs.

### SUMMARY OF THE INVENTION

It is a general object of at least one embodiment of the present invention to provide an image forming apparatus, a method of deleting print request, and a program that substantially obviates one or more problems caused by the limitations and disadvantages of the related art.

One aspect of the embodiments of the present invention may be to provide an image forming apparatus that performs a print process based on a print request for data to be printed including a detecting unit that detects an occurrence of an error by which the print process is ceased; and a deleting unit that checks print request deletion setup information when a request of a user to end a usage and the occurrence of the error ceasing the print process is detected by the detecting unit, and deletes the print request in a case where a setup of deleting the print request is provided at a time of requesting to end the usage.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 illustrates an exemplary structure of a print system of an embodiment;

FIG. 2 illustrates an exemplary hardware structure of a computer of the embodiment;

FIG. 3 illustrates an image forming apparatus of the embodiment;

FIG. 4 is an exemplary processing block chart of a client terminal of the embodiment;

FIG. 5 is an exemplary processing block chart of an authentication server of the embodiment;

FIG. 6 is an exemplary processing block chart of an administrator terminal of the embodiment;

FIG. 7 illustrates an exemplary image forming apparatus of the embodiment;

FIG. 8 is an exemplary processing block chart of a print server of the embodiment;

FIG. 9 illustrates an exemplary structure of job deletion setup information at logout, corresponding to a user;

FIG. 10 is an exemplary structural view of print job information;

FIG. 11 is an exemplary sequence chart of a process for accumulating a print job;

FIG. 12 is an exemplary sequence chart of a print process based on the print job;

FIG. 13 illustrates an exemplary structure including an object of deleting a print job and a corresponding print error; and

FIG. 14 is an exemplary flowchart of a process in an image forming apparatus after a user requests a logout.

### DETAILED DESCRIPTION OF THE PREFERRED EMBODIMENTS

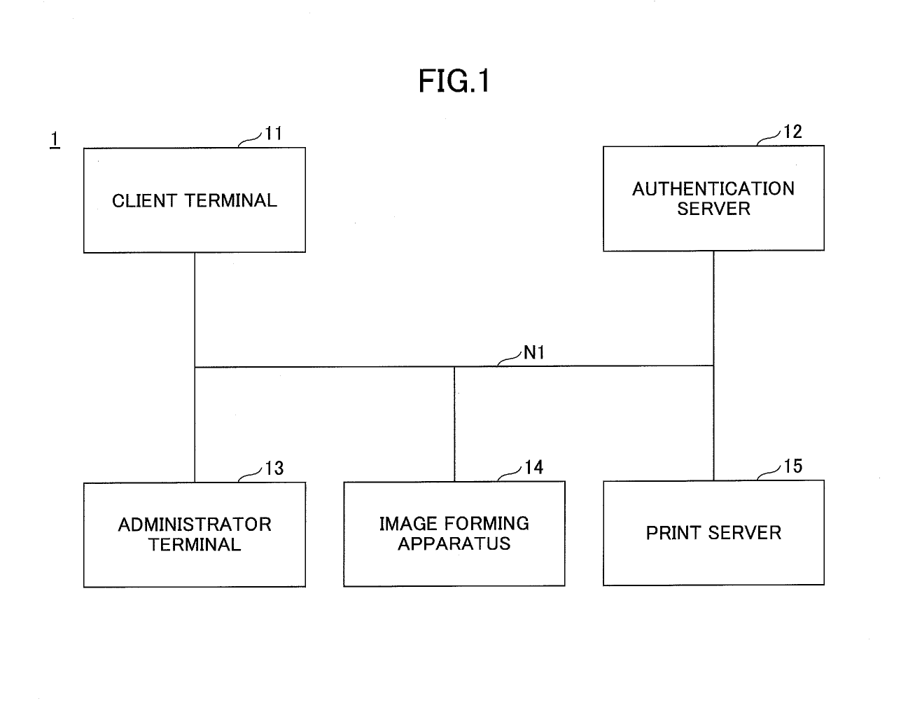

A description is given below, with reference to the FIG. 1 through FIG. 14 of embodiments of the present invention. Where the same reference symbols are attached to the same parts, repeated description of the parts is omitted.

Reference symbols typically designate as follows:
1: print system;
11: client terminal;
12: authentication server;
13: administrator terminal;
14: image forming apparatus;
15: print server;
21: sending unit;
31: sending and receiving unit;
32: job deletion setup processing unit;
33: user authentication information storing unit;
34: job deletion setup storing unit;
41: sending unit;
42: job deletion setup unit;
51: print processing unit;
52: display unit;
53: authentication unit;
54: print job requesting unit;
55: print job deletion processing unit;
56: job deletion setup processing unit;
57: job deletion setup information storing unit;
61: sending and receiving unit;
62: print job acquiring unit;
63: print job storing unit;
500: computer;
501: input device;
502: display device;
503: external I/F;
503a: recording medium;
504: RAM;
505: ROM;
506: CPU;
507: communication I/F;
508: HDD;
601: controller;
602: operation panel;
603: external I/F;
604: communication I/F;
605: printer;
606: scanner;
611: CPU;
612: RAM;
613: ROM;
614: NVRAM;
615: HDD;
B: bus; and
N1: network.

### First Embodiment

### System Structure

FIG. 1 illustrates an exemplary structure of a print system of a first embodiment. The print system 1 includes a client terminal 11, an authentication server 12, an administrator terminal 13, an image forming apparatus 14, and a print server 15 connected through a network such as a LAN. Each of the client terminal 11, the authentication server 12, the administrator terminal 13, the image forming apparatus 14, and the print server 15 have a communication means. Referring to FIG. 1, the number of each of the client terminal 11, the authentication server 12, the administrator terminal 13, the image forming apparatus 14, and the print server 15 is one. However, the number may be multiple.

The client terminal 11 is a terminal apparatus used by a user. The client terminal 11 is a terminal apparatus such as a smartphone, a mobile phone, and a PC. The client terminal 11 sends a print job to the print server 15.

Within the embodiment, the print job is information necessary to cause the image forming apparatus to perform a print process. For example, the print job is information including electronic data to be printed or information (e.g., URL) for designating the electronic data to be printed and print conditions such as color/monochrome or single side/double side.

The authentication server 12 is substantialized by at least one information processing apparatus. The authentication server 12 holds user information and performs authentication based on a request from the image forming apparatus 14 or the like. The administrator terminal 13 is a terminal apparatus used by an administrator. The administrator terminal 13 is a terminal apparatus such as a smartphone, a mobile phone, and a PC.

The administrator terminal 13 is provided to administrate the authentication server 12, the image forming apparatus 14, and the print server 15 in the print system 1. The administrator terminal 13 can give an instruction to the authentication server 12, the image forming apparatus 14, and the print server 15 by using application software or the like installed in the administrator terminal or the like.

The image forming apparatus 14 is an output apparatus such as a printer, a copier, a multifunction peripheral, a laser printer, or the like. The image forming apparatus 14 uses the authentication server 12 to authenticate the user and performs a print process while acquiring a print job list or a print job of the user who is successfully authenticated.

The print server 15 is substantialized by at least one information processing apparatus. The print server 15 accumulates the print job. The print server 15 sends the print job to the image forming apparatus 14 or the like based on a request from the image forming apparatus 14 or the like. The structure of the print system illustrated in FIG. 1 is an example and may be another.

### <Hardware Structure>

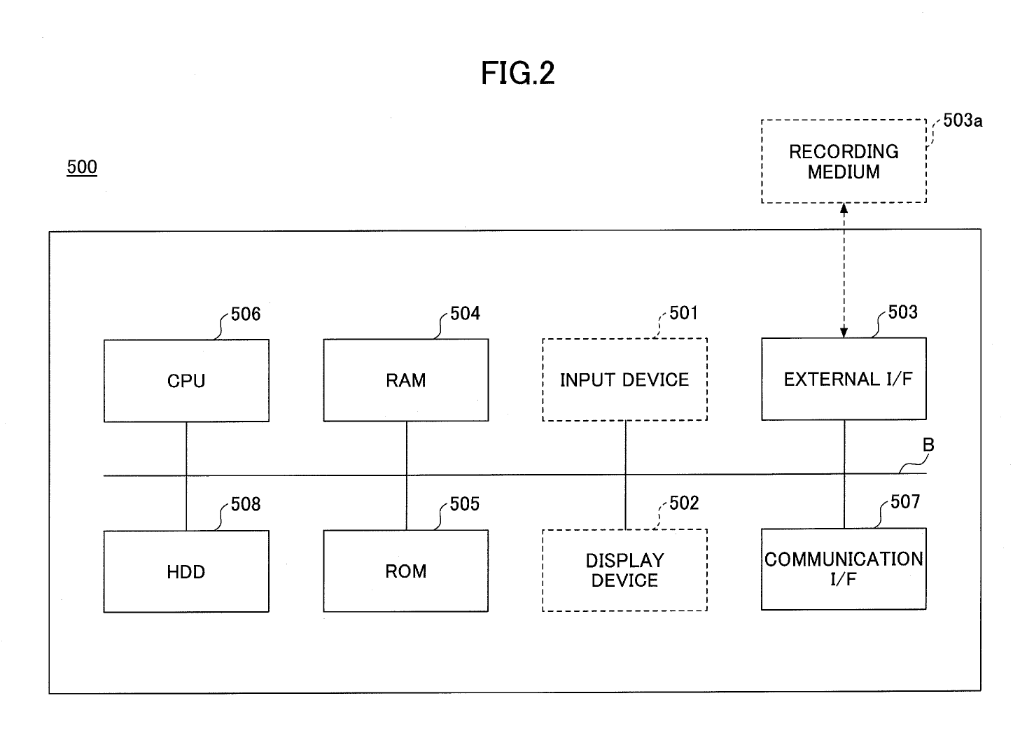

The client terminal 11, the authentication server 12, the administrator terminal 13, and the print server 15 illustrated in FIG. 1 are substantialized by a computer or the like illustrated in FIG. 2. FIG. 2 illustrates an exemplary hardware structure of the computer of the first embodiment.

Referring to FIG. 2, the computer system 500 includes an input device 501, a display device 502, an external I/F 503, a RAM 504, a ROM 505, a CPU 506, a communication I/F 507, a HDD 508, and so on. In the computer system 500, the input device 501, the display device 502, the external I/F 503, the RAM 504, the ROM 505, the CPU 506, the communication I/F 507, the HDD 508, and so on are mutually connected by a bus B. The input device 501 and the display apparatus 502 may be connected to the bus B when necessary.

The input device 501 includes a keyboard, a mouse, or the like, by which the user inputs various operation signals. The display device 502 includes a display or the like to display a processing result obtained by the computer 500.

The communication I/F 507 is an interface provided to connect the computer 500 with the network N1. Thus, the computer system 500 can perform data communications with another device and/or another apparatus through the communication I/F 507.

The HDD 508 is a non-volatile memory device storing programs and/or data. The program and/or data to be stored in the HDD 508 are an (operating system) OS being basic software controlling the entire computer system 500, application software providing various functions in the OS, and so on.

The external I/F 503 is an interface with an external apparatus. The external apparatus is a recording medium 503a or the like. With this, the computer 500 can read information from the recording medium 503a and/or write information to the recording medium 503a through the external I/F 503. The recording medium 503a is a flexible disk, a CD, a DVD, an SD memory card, a USB memory, or the like.

The ROM 505 is a non-volatile semiconductor memory (a memory device), which can hold a program and/or data even when a power source is powered off. The ROM 505 stores programs and data such as basic input/output system (BIOS), OS setup, network setup, or the like, which are executed at a time of booting up the computer 500. The RAM 504 is a volatile semiconductor memory temporarily storing a program or data.

The CPU 506 reads the program and/or data from the memory device such as the ROM 505, the HDD 508, or the like. The read program or the read data undergo a process to thereby substantialize a control or a function of the entire computer 500.

The client terminal 11, the authentication server 12, the administrator terminal 13, and the print server 15 illustrated in FIG. 1 are substantialized by the above-described hardware structure of the computer 500.

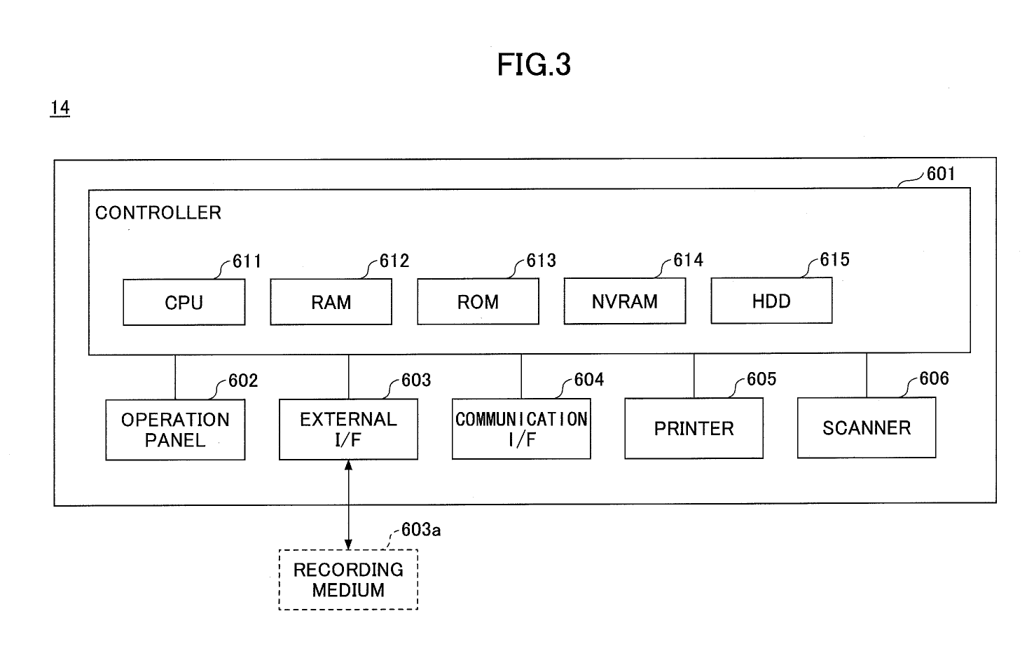

The image forming apparatus 14 illustrated in FIG. 1 is substantialized by a computer having a hardware structure illustrated in, for example, FIG. 3. FIG. 3 illustrates an exemplary hardware structure of the image forming apparatus of the first embodiment. The image forming apparatus 14 includes a controller 601, an operation panel 602, an external I/F 603, a communication I/F 604, a printer 605, a scanner 606, and so on.

The controller 601 includes a CPU 611, a RAM 612, a ROM 613, a NVRAM 614, a HDD 615, and so on. Various programs and data are stored in the ROM 613. The RAM 612 temporarily stores the program and the data. Setup information or the like is stored in the NVRAM 614. Various programs and data are stored in the HDD 615.

The CPU 611 reads the program, the data, and/or setup information into the RAM 612 from the ROM 613, the NVRAM 614, the HDD 615, or the like, and performs the process. Thus, the CPU 611 substantializes an entire control or functions of the information forming apparatus 14.

The operation panel 602 includes an input unit for receiving an input from the user and a display unit for display. The external I/F 603 is an interface with an external apparatus. The external apparatus includes a recording medium 603a or the like. With this, the image forming apparatuses 14 can read information from the recording medium 603a and/or write information to the recording medium 603a through the external I/F 603. The recording medium 603a is an IC card, a flexible disk, a CD, a DVD, an SD memory card, a USB memory, or the like.

The communication I/F 604 is an interface provided to connect the image forming apparatus 14 with the network N1. Thus, the image forming apparatus 14 can perform data communications with another device and/or another apparatus through the communication I/F 604. The printer 605 is provided for printing print data on a print paper. The scanner is an apparatus for reading image data (electronic data) from an original manuscript.

### <Software Structure>

### <<Client Terminal>>

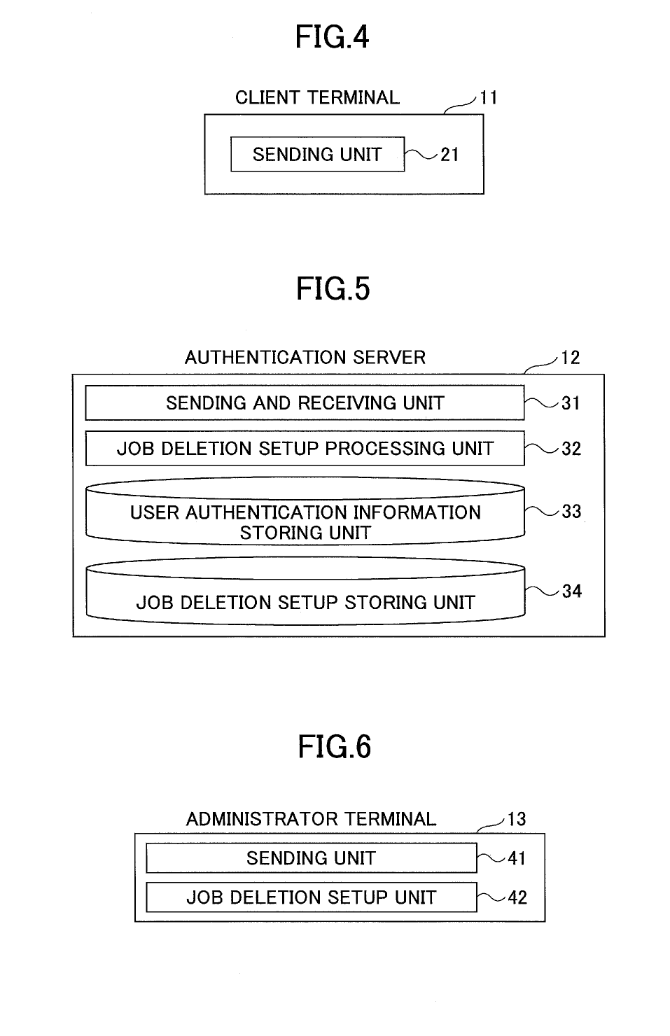

The client terminal 11 of the first embodiment is substantialized by a processing block illustrated in, for example, FIG. 4. FIG. 4 is an exemplary processing block chart of the client terminal of the first embodiment. The client terminal 11 substantializes a sending unit when a program is run in the client terminal 11. The sending unit 21 sends the print job including user information to the print server 15. The processing block chart illustrated in FIG. 4 is provided to explain the first embodiment and may have another processing block.

### <<Authentication Server>>

The authentication server 12 of the first embodiment is substantialized by, for example, a processing block illustrated in FIG. 5. FIG. 5 is an exemplary processing block chart of the authentication server of the first embodiment. The authentication server 12 substantializes a sending and receiving unit 31, a job deletion setup processing unit 32 used at a time of logout, a user authentication information storing unit 33, and a job deletion setup storing unit 34 used at the time of logout, when a program is run in the authentication server 12.

The sending and receiving unit 31 sends or receives job deletion setup information used at the time of logout and corresponding to the user. The job deletion setup processing unit 32 receives a logout request from the image forming apparatus 14 and reads the job deletion setup information corresponding to the logging-out user from the job deletion setup storing unit 34. The user authentication information storing unit 33 stores information used for authentication of the user information or the like. The job deletion setup storing unit 34 stores the job deletion setup information used at the time of logout. The job deletion setup information is described later in detail.

### <<Administrator Terminal>>

The administrator terminal 13 of the first embodiment is substantialized by the processing block illustrated in, for example, FIG. 6. FIG. 6 is an exemplary processing block chart of the administrator terminal of the first embodiment. The administrator terminal 13 substantializes a sending unit 41 and a job deletion setup unit 42 used at the time of logout.

The sending unit 41 sends the job deletion setup information to the image forming apparatus 14. The job deletion setup information sent to the image forming apparatus 14 is used by the image forming apparatus 14 to determine whether a job deletion setup is done at the time of logout.

Further, the sending unit 41 sends the job deletion setup information corresponding to the user to the authentication server 12. The job deletion setup information corresponding to the user who sends the job deletion setup information to the authentication server 12 is used to determine whether the job deletion setup used at the time of logout is provided to the user when the user logs out.

The job deletion setup unit 42 receives a setup of the job deletion setup information sent from the administrator or the like to the image forming apparatus 14, or the job deletion setup information corresponding to the user who sends the job deletion setup information to the authentication server 12. The processing block chart illustrated in FIG. 6 is provided to explain the first embodiment and may have another processing block.

### <<Image Forming Apparatus>>

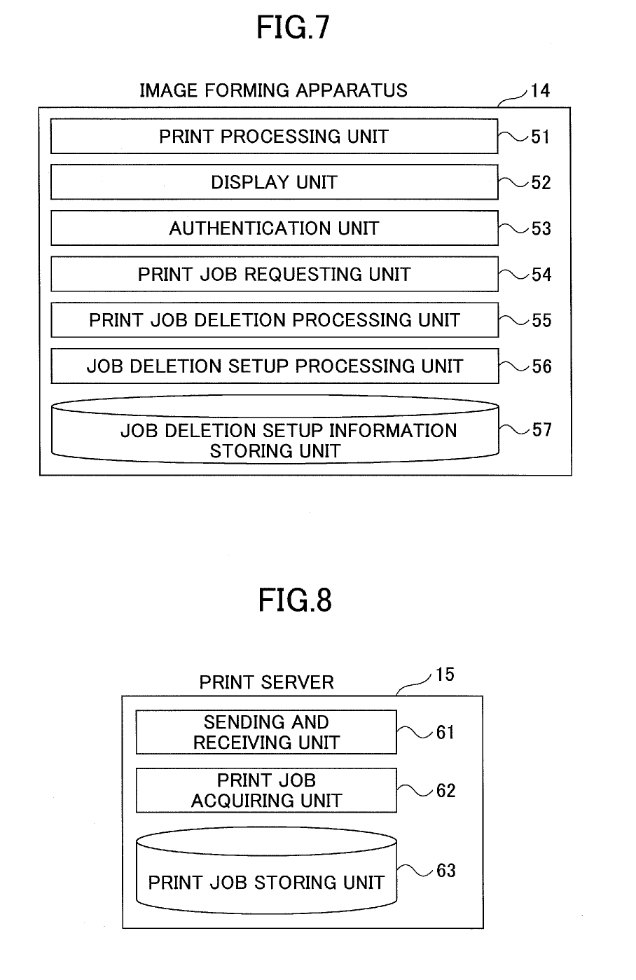

The image forming apparatus 14 of the first embodiment is substantialized by the processing block illustrated in, for example, FIG. 7. FIG. 7 illustrates a processing block chart of an exemplary image forming apparatus of the first embodiment.

The image forming apparatus 14 substantializes a print processing unit 51, a display unit 52, an authentication unit 53, a print job requesting unit 54, a print job deletion processing unit 55, a job deletion setup processing unit 56 used at the time of logout, and a job deletion setup information storing unit 57 used at the time of logout when a program is run in the image forming apparatus 14.

The print processing unit 51 performs a print process based on the print job received from the print server 15. When a print error occurs by a paper jam or the like, the print processing unit 51 requests the display unit 52 so that the print error is sent to the user. Further, when the print error occurs, the print processing unit 51 ceases the print process and reports the occurrence of the print error to the job deletion setup processing unit 56.

The display unit 52 displays the occurrence of the print error based on a request from the print processing unit 51. The authentication unit 53 receives a request of login or logout from the user and performs login to apparatus authentication or logout from the apparatus authentication using the authentication server 12.

The print job requesting unit 54 receives the login of the user, requests a print job associated with the user to the print server 15, and receives the print job associated with the user from the print server 15.

The print job deletion processing unit 55 receives a request of deleting the print job and performs the process of deleting the print job held (spooled) by the image forming apparatus 14. When the logout is requested from the user, the job deletion setup processing unit 56 refers to the job deletion setup information storing unit 57 to determine whether the job deletion setup that is used at the time of logout is done.

The job deletion setup processing unit 56 determines whether the occurrence of the print error is reported from the print processing unit 51. Further, the job deletion setup processing unit 56 inquires of the authentication server 12 for whether the job deletion setup is provided to the user who logs out at the time of logout.

The job deletion setup processing unit 56 determines to delete the print job in a case where the user requests logout, the image forming apparatus 14 is provided with the job deletion setup, and the user who logs out is provided with the job deletion setup. The job deletion setup processing unit 56 requests the print job deletion processing unit 55 to delete the print job. The job deletion setup information storing unit 57 stores the job deletion setup information received from the administrator terminal 13.

### <<Print Server>>

The print server 15 of the first embodiment is substantialized by, for example, a processing block illustrated in, for example, FIG. 8. FIG. 8 is an exemplary processing block chart of the print server of the first embodiment.

The print server 15 illustrated in FIG. 8 substantializes a sending and receiving unit 61, a print job acquiring unit 62, and a print job storing unit 63 when the print server runs a program. The sending and receiving unit 61 sends or receives the print job or the like associated with the user. The print job acquiring unit 62 receives a request of the print job associated with the user from the image forming apparatus 14 or the like. The print job acquiring unit 62 reads the print job associated with the user from the print job storing unit 63 and sends the print job associated with the user to the image forming apparatus 14. The print job storing unit 63 stores the print job in association with the user (the user ID as an example of the user information).

### <<Job Deletion Setup Information Used at a Time of Logout>>

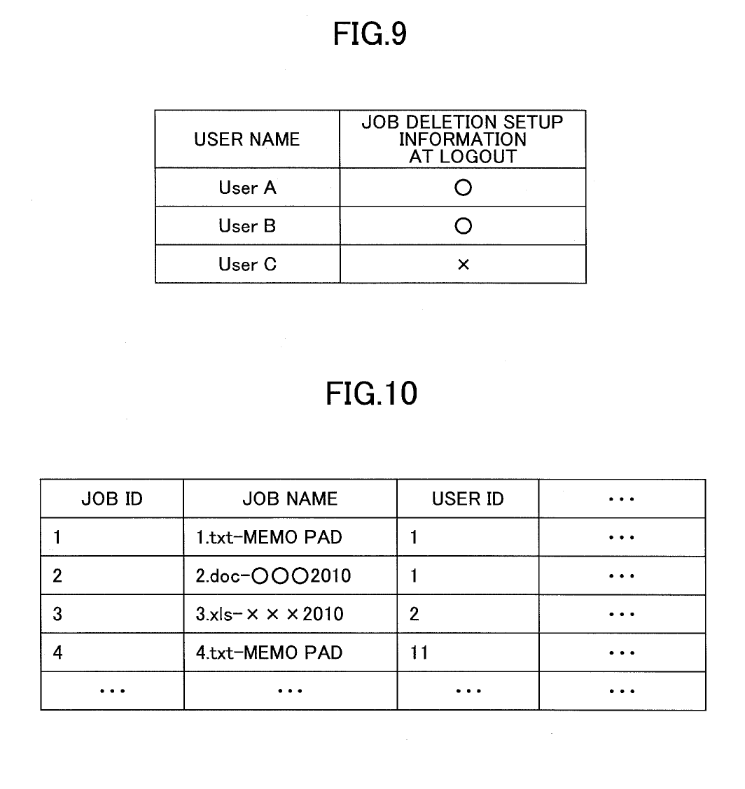

Referring to FIG. 9, the job deletion setup information is used at the time of logout and corresponds to users. The job deletion setup information is stored in the job deletion setup storing unit 34 of the authentication server 12. The job deletion setup information used at the time of logout and corresponding to the user has information of whether the job deletion setup is provided in association with the user name which is an example of the information for identifying the user.

Therefore, the image forming apparatus 14 can determine whether the job deletion setup is provided by using the job deletion setup information corresponding to the user illustrated in FIG. 9. The job deletion setup information corresponding to the user illustrated in FIG. 9 is an example, and the job deletion setup information may be added to information which is stored in the user authentication information storing unit 33 and used for authentication. In this case, the job deletion setup storing unit 34 may be omitted from the authentication server 12 illustrated in FIG. 5.

### <<Print Job Information>>

FIG. 10 is an exemplary structural view of print job information. The print job information includes items such as a job ID, a job name, a user ID, and so on. The job ID is identification information for uniquely identifying the print job. The job name is the name of the print job, for example, a document name of the print data. The user ID is identification information for identifying the user who has stored the print job in the print server 15. For example, when the user who has logged in requests registration of the print job, the print job information of the print job which is requested by the user to register is registered in association with the user ID as illustrated in FIG. 10.

### <Detailed Process>

Hereinafter, a detailed process of the print system 1 of the first embodiment is described.

### <<Process for Accumulating Print Job>>

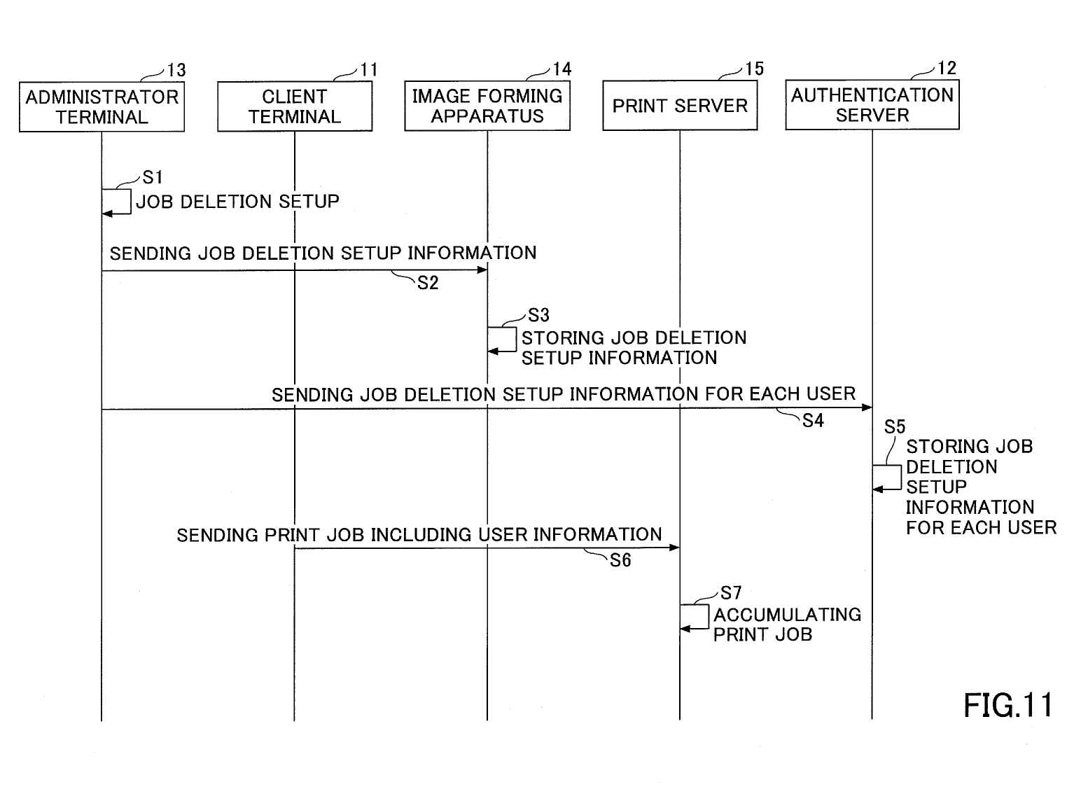

FIG. 11 is an exemplary sequence chart of a process for accumulating the print job. In step S1, the job deletion setup unit 42 of the administrator terminal 13 receives a setup of the job deletion setup information which is sent from the administrator or the like to the image forming apparatus 14 or a setup of the job deletion setup information which corresponds to the user and is sent to the authentication server 12.

In step S2, the sending unit 41 of the administrator terminal 13 sends the job deletion setup information to the image forming apparatus 14. In step S3, the job deletion setup information storing unit 57 of the image forming apparatus 14 stores the job deletion setup information received from the administrator terminal 13. In step S4, the sending unit 41 of the administrator terminal 13 sends the job deletion setup information corresponding to the user to the authentication server 12. In step S5, the job deletion setup information storing unit 34 of the authentication server 12 stores the job deletion setup information corresponding to the user and received from the administrator terminal 13.

The processes of steps S1 to S4 set the job deletion setup information which is sent from the administrator or the like from the administrator terminal 13 to the image forming apparatus 14 or the job deletion setup information which corresponds to the user and is sent to the authentication server 12.

In step S6, the sending unit 21 of the client terminal 11 sends the print job including (added with) the user information to the print server 15 based on a request from the user for accumulating the print job. In step S7, the print job storing unit 63 of the print server 15 accumulates the print job by storing the print job information of the print job received from the client terminal 11 in the print job storing unit 63 as illustrated in FIG. 10.

### <<Print Process Based on Print Job>>

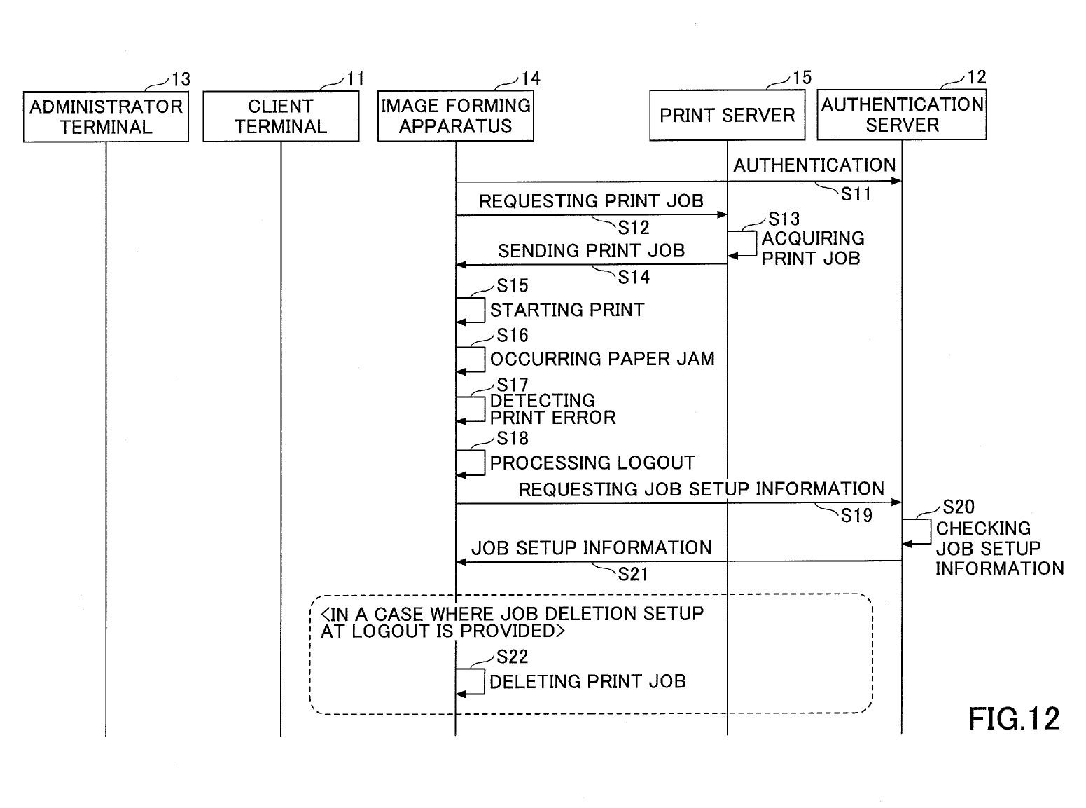

FIG. 12 is an exemplary sequence chart of a print process based on the print job. In step S11, the user requests for a display of, for example, a login screen by operating the operation panel 602 of the image forming apparatus 14.

The display unit 52 of the image forming apparatus 14 receives an operation by the user and causes the operation panel 602 to display the login screen. The operation panel 602 receives an input of the user information onto the login screen from the user. The user information is, for example, the user ID, the password, or the like. The authentication unit 53 requests the authentication server 12 to authenticate the user information input by the user and logs in the apparatus authentication. Hereinafter, a description is given for a case where the login to the apparatus authentication is successful.

In step S12, the print job requesting unit 54 of the image forming apparatus 14 is logged in by the user and requests the print job associated with the user to the print server 15. In step S13, the print job acquiring unit 62 of the print server 15 acquires the print job associated with the user from the print job storing unit 63. In step S14, the sending and receiving unit 61 of the print server 15 sends the print job associated with the user to the image forming apparatus 14.

In step S15, the print processing unit 15 of the image forming apparatus 14 starts the print process based on the print job received from the print server 15. An example that paper jam occurs in step S16 after the print process is started based on the print job is illustrated in a sequence chart illustrated in FIG. 12. In step S16, the paper jam occurs in the print processing unit 51 of the image forming apparatus 14.

When a print error occurring by the paper jam is detected by the print processing unit 51 in step S17, the print processing unit 51 requests the display unit 52 to report the print error to the user. Further, the print processing unit 51 ceases the print process based on the print job when the print error occurs. The display unit 52 displays the occurrence of the print error based on a request from the print processing unit 51.

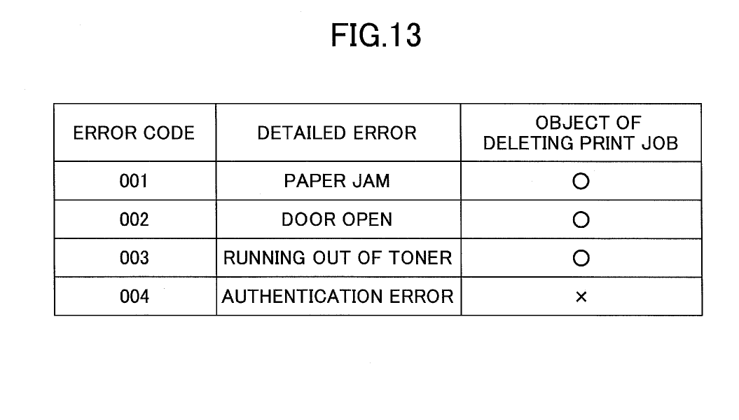

Further, the print processing unit 51 refers to information indicative of the print error whose print job is to be deleted as illustrated in FIG. 13. When the print error whose print job is to be deleted occurs, the print processing unit 51 reports the occurrence of the print error to the job deletion setup processing unit 56.

FIG. 13 illustrates an exemplary structure of the print error whose print job is to be deleted. Referring to FIG. 13, information of whether the print job is to be deleted is included for each error code of the print error. For example, referring to FIG. 13, “paper jam”, “door open”, and “running out of toner” are the print error whose print job is to be deleted.

In the sequence chart of FIG. 12, an example where the user who has checked the occurrence of the print error performs a logout operation in step S18 is illustrated. In step S18, the authentication unit 53 of the image forming apparatus 14 receives a request for the logout from the user and starts the logout process of logging out the apparatus authentication by using the authentication server 12.

When the logout is requested from the user, the job deletion setup processing unit 56 of the image forming apparatus 14 refers to the job deletion setup information storing unit 57 to determine whether the job deletion setup that is used at the time of logout is provided.

In a case where the job deletion setup is provided and the occurrence of the print error is reported from the print processing unit 51, the job deletion setup processing unit 56 performs the process of step S19. In step S19, the job deletion setup processing unit 56 requests the authentication server 12 to send the job deletion setup information corresponding to the user who logs out.

In step S20, the job deletion setup processing unit 32 of the authentication server 12 reads the job deletion setup information corresponding to the user who logs out from the job deletion setup storing unit 34. In step S21, the job deletion setup processing unit 32 sends the job deletion setup information corresponding to the user who logs out to the image forming apparatus 14.

The job deletion setup processing unit 56 of the image forming apparatus 14 determines that the print job held by the image forming apparatus is deleted when the job deletion setup corresponding to the user who logs out is provided. When the job deletion setup processing unit 56 determines that the print job held by the image forming apparatus 14 is deleted, the job deletion setup processing unit 56 requests the print job deletion processing unit 55 to delete the print job in step S22. The print job deletion processing unit 55 performs a process of deleting the print job held by the image forming apparatus 14.

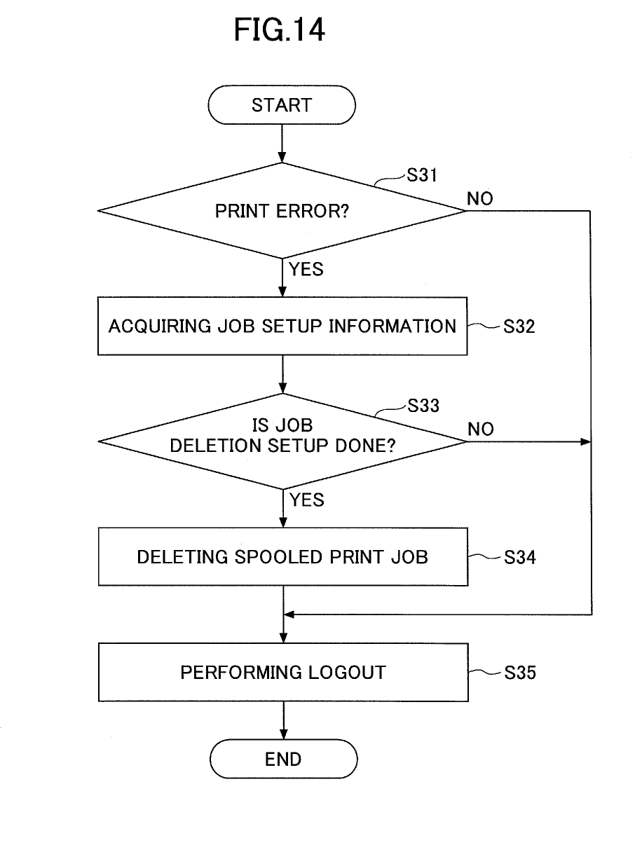

A process of the image forming apparatus 14 after the user requests to logout is further described with reference to a flowchart illustrated in FIG. 14. FIG. 14 is an exemplary flowchart of the process in the image forming apparatus after the user requests for the logout.

In step S31, the job deletion setup processing unit 56 of the image forming apparatus 14 determines whether the occurrence of the printer error is reported from the print processing unit 51. If the occurrence of the print error is not reported from the print processing unit 51, the process goes to step S35 and the authentication unit 53 of the image forming apparatus 14 performs the logout.

On the other hand, if the occurrence of the print error is reported from the print processing unit 51, the job deletion setup processing unit 56 acquires the job deletion setup information stored in the job deletion setup information storing unit 57 in step S32. Further, the job deletion setup processing unit 56 acquires the job deletion setup information corresponding to the user who logs out and stored in the job deletion setup storing unit 34 of the authentication server 12.

In step S33, the job deletion setup processing unit 56 determines whether the image forming apparatus 14 is provided with the job deletion setup and whether the user who logs out is provided with the job deletion setup.

The job deletion setup processing unit 56 goes to step S34 and processes step S34 in a case where the job deletion process is provided to the image forming apparatus 14 and further the job deletion setup is provided to the user who logs out.

In step S34, the print job deletion processing unit 55 of the image forming apparatus 14 deletes the print job held (stored) in the image forming apparatus 14. The range of the print jobs deleted by the print job deletion processing unit 55 may be all print jobs including a print job accumulated by another user a print job for direct printing or a print job associated with a user who logs out.

### <General Overview>

According to the print system 1 of the first embodiment, the print job ceased by the occurrence of the print error is deleted in a case where the user logs out from the image forming apparatus 14 in which the print error occurs.

Therefore, according to the print system 1 of the first embodiment, the print process ceased by the occurrence of the print error is resumed by solving the print error thereby preventing a printed document being unintentionally viewed by another user. According to the print system 1 of the first embodiment, the security of the image forming apparatus 14, in which the print error occurs, can be improved.

A print request of data to be printed recited in claims corresponds to a print job. An error ceasing the print process recited in the claims corresponds to the print error whose print job is to be deleted. A detecting unit recited in the claims corresponds to the print processing unit 51.

A request of the user to end a usage in the claims corresponds to a request for the logout. Print request deletion setup information in the claims corresponds to the job deletion setup information used at the time of logout. A setup of deleting the print request at a time of requesting to end the usage in the claims corresponds to the job deletion setup used at the time of logout. A deleting unit in the claims corresponds to the job deletion setup processing unit 56 used at the time of logout. Information including an error that occurs in the image forming apparatus and ceases the print process in the claims corresponds to the information indicative of the print error whose print job is to be deleted illustrated in FIG. 13.

Within the first embodiment of the present invention, security in the image forming apparatus where the error occurs can be improved.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although an image forming apparatus has been described in detail, it should be understood that various changes, substitutions, and alterations could be made thereto without departing from the spirit and scope of the invention.

This application is based upon and claims the benefit of priority of the prior Japanese Patent Application No. 2013-226355, filed on Oct. 31, 2013, the entire contents of which are incorporated herein by reference.

What is claimed is:

1. An image forming apparatus that performs a print process based on a print request for data to be printed, the image forming apparatus comprising:
a detecting unit that detects an occurrence of an error by which the print process is ceased; and
a deleting unit that checks print request deletion setup information when a request of a user to end a usage and the occurrence of the error ceasing the print process is detected by the detecting unit, and deletes the print request in a case where a setup of deleting the print request is provided at a time of requesting to end the usage.

2. The image forming apparatus according to claim 1,
wherein the deleting unit checks the print request deletion setup information of the image forming apparatus and the print request deletion setup information corresponding to the user, and deletes the print request in a case where the setup of deleting the print request is provided to the image forming apparatus and the user who requests to end the usage at the time of requesting to end the usage.

3. The image forming apparatus according to claim 1,
wherein the deleting unit deletes all the print requests stored in the image forming apparatus.

4. The image forming apparatus according to claim 1,
wherein the deleting unit deletes the print request, which is stored in the image forming apparatus and is associated with the user who requests to end the usage.

5. The image forming apparatus according to claim 1,
wherein the detecting unit checks information including an error which occurs in the image forming apparatus and ceases the print process, and detects the occurrence of the error ceasing the print process in the image forming apparatus.

6. A method of deleting a print request for data to be printed in an image forming apparatus that performs the print process based on the print request, the method comprising:
detecting, by a detecting unit, an occurrence of an error by which the print process is ceased;
checking, by a deleting unit, print request deletion setup information when a request of a user to end a usage and the occurrence of the error ceasing the print process is detected by the detecting unit; and
deleting, by the deleting unit, the print request in a case where a setup of deleting the print request is provided at a time of requesting to end the usage.

7. The method according to claim 6,
wherein the deleting checks the print request deletion setup information of the image forming apparatus and the print request deletion setup information corresponding to the user, and deletes the print request in a case where the setup of deleting the print request is provided to the image forming apparatus and the user who requests to end the usage at the time of requesting to end the usage.

8. The method according to claim 6,
wherein the deleting deletes all the print requests stored in the image forming apparatus.

9. The method according to claim 6,
wherein the deleting deletes the print request, which is stored in the image forming apparatus and is associated with the user who requests to end the usage.

10. The method according to claim 6,
wherein the detecting checks information including an error which occurs in the image forming apparatus and ceases the print process, and detects the occurrence of the error ceasing the print process in the image forming apparatus.

11. A non-transitory computer-readable storage medium storing a program for causing a computer to function as an image forming apparatus that performs a print process based on a print request for data to be printed, the image forming apparatus comprising:
a detecting unit that detects an occurrence of an error by which the print process is ceased; and
a deleting unit that checks print request deletion setup information when a request of a user to end a usage and the occurrence of the error ceasing the print process is detected by the detecting unit, and deletes the print request in a case where a setup of deleting the print request is provided at a time of requesting to end the usage.

12. The non-transitory computer-readable storage medium according to claim 11,
wherein the deleting unit checks the print request deletion setup information of the image forming apparatus and the print request deletion setup information corresponding to the user, and deletes the print request in a case where the setup of deleting the print request is provided to the image forming apparatus and the user who requests to end the usage at the time of requesting to end the usage.

13. The non-transitory computer-readable storage medium according to claim 11,
wherein the deleting unit deletes all the print requests stored in the image forming apparatus.

14. The non-transitory computer-readable storage medium according to claim 11,
wherein the deleting unit deletes the print request, which is stored in the image forming apparatus and is associated with the user who requests to end the usage.

15. The non-transitory computer-readable storage medium according to claim 11,
wherein the detecting unit checks information including an error which occurs in the image forming apparatus and ceases the print process, and detects the occurrence of the error ceasing the print process in the image forming apparatus.
